(19) United States
(12) Patent Application Publication
(10) Pub. No.: US 2014/0309378 A1
(43) Pub. Date: Oct. 16, 2014

(54) RESIN COMPOSITION

(71) Applicant: DSM IP ASSETS B.V., Heerlen (NL)

(72) Inventors: Johan Franz Gradus Antonius Jansen, Echt (NL); Iris Hilker, Echt (NL); Guido Joseph Elisabeth Hensen, Echt (NL); Silvana Rensina Antonnietta Di Silvestre, Echt (NL)

(21) Appl. No.: 14/363,404

(22) PCT Filed: Dec. 5, 2012
(86) PCT No.: PCT/EP2012/074509

§ 371 Date: Jun. 6, 2014

(30) Foreign Application Priority Data
Dec. 6, 2011 (EP) 11192141.7

(51) Int. Cl. C08F 283/01

(52) U.S. Cl. CPC C08F 283/01
USPC 525/445

(57) ABSTRACT

This invention relates to an unsaturated polyester resin composition characterized in that the resin composition comprises a. An unsaturated polyester resin comprising fumaric, maleic and/or itaconic building blocks, b. At least one vinyl ester as reactive diluent, c. An iron complex and/or salt, and d. A ligand according to the following formula (1) wherein each R₁, R₂, R₃ and R₄ are independently selected from hydrogen, C1-C12 alkyl, C3-C8 cycloalkyl, C6-C12 aryl and C5-C12 heteroaryl; X is selected from C=0 and —[C(R)₂]_{z}— wherein z is from 1 to 3 and each R is independently selected from hydrogen, hydroxyl, C1-C4 alkoxy and C1-C4 alkyl; each Rx and Ry are independently selected from hydrogen, C1-C8 alkyl, (C1-C8)alkyl-0-(C1-C8)alkyl, (C1-C8)alkyl-O—(C6-C10)aryl, C6-C10-aryl, C1-C8-hydroxyalkyl, and (CH2)_{b}C(O)OR₅ wherein n is from 0 to 4 and R₅ is hydrogen, C1-C12 alkyl or an amide; Ra is a 2-pyridyl group or an alkylidene-2-pyridyl group; Rb is selected from C1-C24 alkyl, C6-C10 aryl and a group containing a heteroatom.

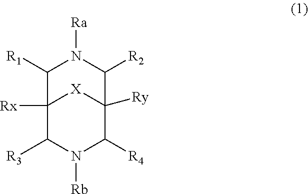

The invention relates to room temperature radically curable, thermosetting resin compositions comprising an unsaturated polyester resin comprising fumaric, maleic and/or itaconic building blocks and a vinyl ester as reactive diluent (copolymerizable solvent).

Unsaturated polyester (UP) resin compositions are widely used for various applications such as for instance in boats, windmill blades, tanks and pipes, SMC, BMC etc. Nowadays styrene is still commonly applied as reactive diluent of choice. In fact many of the desired properties of the cured UP resins are due to the use of styrene.

Curing of resin compositions comprising an unsaturated polyester resin can be done by a free-radical chain growth crosslinking polymerization between the reactive diluent and the resin present in the resin composition. Peroxides can be used as initiators of free-radical chain growth crosslinking polymerization. To accelerate the decomposition of the peroxide, an accelerator can be used. The state of the art unsaturated polyester resin systems in styrene generally are being cured under the influence of peroxides and are frequently pre-accelerated by the presence of metal compounds like for instance cobalt salts. Cobalt naphthenate and cobalt octanoate are the most widely used accelerators. See for instance EP-0761737-A1, JP-42005092 B, U.S. Pat. No. 4,329,263, U.S. Pat. No. 3,584,076, U.S. Pat. No. 3,297,789. An excellent review article of M. Malik et al. in J. M. S.—Rev. Macromol. Chem. Phys., C40(2&3), p. 139-165 (2000) gives a good overview of the current status of these resin systems. Curing is addressed in chapter 9.

Styrene has a strong beneficial effect on the desired mechanical properties of the cured composition. It has been found very difficult to replace styrene with other reactive diluents without detrimental affecting the mechanical properties of the cured objects. However due to environmental reasons, especially the increased concerns around the safety of the workers when working with unsaturated polyester resins in styrene there is a strong desire to replace styrene in unsaturated polyester resin compositions without negatively affecting the curing and or the mechanical properties too much.

The possibility to use vinyl esters as styrene replacement in light of the above mentioned environmental concerns has already been reported by Froehling in 1982 (Journal of Applied Polymer Science, Vol. 27, p. 3577-3584 (1982)). In this paper he described the curing of Unsaturated Polyester (UP)-Vinyl ester mixtures using the well known Cobalt based or a Vanadium based system. The fact that he used a cure profile of 24 hrs at room temperature followed by 24 hrs at 60° C. and by 24 hrs at 80° C. or 100° C., i.e. a total cure cycle of 72 hrs, strongly indicates that the standard Co or V based cure systems are insufficient with respect to reactivity at lower temperatures, like for instance room temperature, when using vinyl esters as reactive diluent. In fact as will be demonstrated in the experimental part using V in low amounts or Co it is very difficult to cure an unsaturated polyester resin diluted in a vinyl ester at room temperature. Furthermore, Froehling states that curing with vinyl esters does not give mechanical properties comparable to curing with styrene.

Besides this insufficient reactivity at room temperature, both metal catalysts suffer from other serious drawbacks. For instance the use of cobalt salts as transition metal catalyst in UP resins is nowadays of even higher environmental concern than styrene as it is even anticipated that the used cobalt salts will be classified as being carcinogenic. Toxicological background can be found in J. Environ. Monit., 2003, 5, 675-680,. Woodhall Stopford et al., Bioaccessability testing of cobalt compounds. Using Vanadium always results in dark green objects, thereby making it unsuitable for any application in which colours are important such as for instance gel coats. Furthermore using vanadium can have a detrimental influence on the storage stability. For example using an unsaturated polyester resin in styrene and a vanadium complex, the storage stability is limited as the resin with the V inside gelled spontaneously within 2 weeks of storage. Consequently there is still a need for an efficient cure system especially at room temperature for unsaturated polyesters resins diluted in vinyl esters diluents.

The object of the present invention is to improve the curing efficiency at room temperature of unsaturated polyesters resins diluted in vinyl esters.

The inventors have surprisingly found that this object can be achieved in that the resin composition comprises
a. An unsaturated polyester resin comprising fumaric, maleic and/or itaconic building blocks,
b. At least one vinyl ester as reactive diluent,
c. An iron complex and/or salt, and
d. A ligand according to the following formula (1)

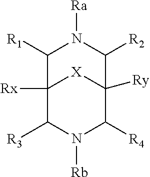

wherein each R₁, R₂, R₃ and R₄ are independently selected from hydrogen, C1-C12 alkyl, C3-C8 cycloalkyl, C6-C12 aryl and C5-C12 heteroaryl; X is selected from C═O and —[C(R)₂]— wherein z is from 1 to 3 and each R is independently selected from hydrogen, hydroxyl, C1-C4 alkoxy and C1-C4 alkyl;
each Rx and Ry are independently selected from hydrogen, C1-C8 alkyl, (C1-C8)alkyl-O—(C1-C8)alkyl, (C1-C8)alkyl-O—(C6-C10)aryl, C6-C10aryl, C1-C8 hydroxyalkyl, and (CH₂)nC(O)OR₅ wherein n is from 0 to 4 and R₅ is hydrogen, C1-C12 alkyl or an amide;
Ra is a 2-pyridyl group or an alkylidene-2-pyridyl group; Rb is selected from C1-C24 alkyl, C6-C10 aryl and a group containing a heteroatom.

Without wishing to be bound by any theory, it is believed that the complex of iron with the ligand according to formula (1) accelerates the peroxide initiated radical copolymerization of the resin composition comprising unsaturated polyester resin and vinyl ester.

Thermosetting resin compositions harden by chemical reaction, often generating heat when they are formed, and cannot be melted or readily re-formed once hardened. The resin compositions are liquids at normal temperatures and pressures, so can be used to impregnate reinforcements, for instance fibrous reinforcements, especially glass fibers, and/or fillers may be present in the resin composition, but, when treated with suitable radical forming initiators, the various unsaturated components of the resin composition crosslink with each other via a free radical copolymerization mechanism to produce a hard, thermoset plastic mass (also referred to as structural part).

Preferably, R₁ and/or R₂ is hydrogen. In a preferred embodiment, R₁ and R₂ are hydrogen.

Preferably, R₃ and/or R₄ is a 2-pyridyl group. More preferably both R3 and R4 are a 2-pyridyl group.

Preferably, X is selected from C═O and CH₂. More preferably, X is C═O.

Preferably, each Rx and Ry are independently selected from C6-C10-aryl and (CH₂)ₙC(O)OR₅ wherein n is from 0 to 4 and R₅ is hydrogen, C1-C12 alkyl or an amide. More preferably, each Rx and Ry are independently selected from C6 aryl and C(O)OR₅ wherein R₅ is C1-C4 alkyl. Even more preferably, each Rx and Ry are independently selected from C(O)OR₅ wherein R₅ is C1-C4 alkyl. In a preferred embodiment, Rx and Ry are the same. Preferably, Rx and Ry are C(O)OCH₃ (i.e. R₅ is methyl).

Preferably, Ra is an alkylidene-2-pyridyl group and more preferably Ra is methylene-2-pyridyl.

Preferably, Rb is C1-C12 alkyl, more preferably Rb is methyl or octyl and even more preferably, Rb is methyl.

Preferably, the resin composition comprises an iron²⁺ salt or complex or iron³⁺ salt or complex. Non-limiting examples of suitable iron salt and complexes are iron carboxylates such iron ethyl hexanoate and iron naphthenate; iron acetoacetates; iron acetyl acetonates: iron halides such as iron chloride . It will be clear that, instead of a single iron salt or complex also a mixture of iron salts and complexes can be used.

In a preferred embodiment according to the present invention, the resin composition comprises an iron complex with the ligand according to formula (1). In one embodiment, such iron complex is formed in situ by adding, to a resin composition comprising an unsaturated polyester resin and a vinyl ester reactive diluent, the ligand according to formula (1) and an iron salt or an iron complex (with a ligand not according to formula (1)). In another and more preferred embodiment, an iron complex with the ligand according to formula (1) (a preformed complex of iron and ligand according to formula (1)) is added to a resin composition comprising an unsaturated polyester resin and a vinyl ester. In this embodiment of the invention, the iron in the complex is preferably present as an iron²⁺ or iron³⁺ salt. Although in view of solubility organic iron salts are preferred, in view of ease of formation simple iron halides are preferred especially iron chlorides.

The ligands according to formula (1) and iron complexes thereof can be prepared according to methods known in the art, as for example described in WO0248301.

Preferably, the ligand is present in the resin composition in an amount of at least 0.2 μmol per kilogram of primary resin system, more preferably in an amount of at least 0.5 μmol, even more preferably in an amount of at least 1 μmol, even more preferably in an amount of at least 5 μmol and even more preferably in an amount of at least 10 μmol. Preferably, the ligand is present in the resin composition in an amount of at most 4000 μmol per kilogram of primary resin system, more preferably in an amount of at most 3000 μmol, even more preferably in an amount of at most 2000 μmol, even more preferably in an amount of at most 1000 μmol and even more preferably in an amount of at most 500 μmol. In a preferred embodiment, the amount of ligand according to formula (1) in the resin composition is from 1 to 2000 μmol per kilogram of primary resin system.

Preferably, the iron salt or complex is present in the resin composition in such an amount that the amount of iron in the resin composition is at least 0.2 μmol per kilogram of primary resin system, more preferably at least 0.5 μmol, even more preferably at least 1 μmol, even more preferably at least 5 μmol and even more preferably at least 10 μmol. Preferably, the iron salt or complex is present in the resin composition in such an amount that the amount of iron in the resin composition is at most 4000 μmol per kilogram of primary resin system, more preferably at most 3000 pmol, even more preferably at most 2000 μmol, even more preferably at most 1000 pmol and even more preferably at most 500 μmol. In a preferred embodiment, the amount of iron in the resin composition is from 1 to 2000 μmol per kilogram of primary resin system.

Preferably, the molar ratio of iron to ligand according to formula (1) is from 0.02 to 20, more preferably from 0.02 to 10, even more preferably from 0.2 to 5, even more preferably from 0.5 to 2 and even more preferably from 1 to 2 and even more preferably iron and ligand according to formula (1) are present in an equimolar amount.

As used herein, the term primary resin system means the combination of the unsaturated polyester resin(s), the vinyl ester(s) and optionally (in case present) other reactive diluent(s).

As used herein, a vinyl ester compound (also referred to as vinyl ester) is a compound comprising at least one CH₂═CHOCO—. Thus, according to this definition, a vinyl ester resin is not to be considered a vinyl ester compound since a vinyl ester resin is a methacrylate (CH₂═CMeCOO—) functional resin or acrylate (CH₂═CHCOO—) functional resin.

In one embodiment of the invention, the resin composition according to the invention preferably comprises a vinyl ester according to formula (2)

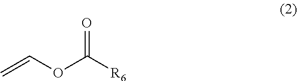

in which R6 is a C1-C24 alkyl, a C6-C12 aryl, a C7-C18 aryl alkyl or a C7-C18 alkyl aryl (which may be substituted with a hetero-atom). Non-limiting examples of compounds according to formula (2) are vinyl acetate, vinyl propionate, vinyl butyrate, vinyl 2-ethylhexanoate, vinyl neodecanoate, vinyl benzoate and vinyl versatate.

In another embodiment of the invention, the resin composition according to the invention preferably comprises a divinyl ester according to formula (3)

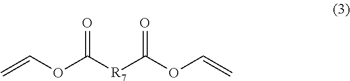

in which R7 is a C1-C24 alkyl, C6-C12 aryl, C7-C18 aryl alkyl or a C7-C18 alkyl aryl (which may be substituted with a hetero-atom). Non-limiting examples of compounds according to formula (3) are divinyl adipate, divinyl phthalate and divinyl succinate

Also various mixtures of various vinyl esters can be employed. In still another embodiment, the vinyl ester(s) present in the resin composition according to the invention is (are) according to formula (2) and/or (3).

The composition according to the invention preferably comprises from 30 to 85 wt. % of unsaturated polyester resin comprising fumaric, maleic and/or itaconic building blocks. Fumaric building blocks and maleic building blocks are introduced in the unsaturated polyester resin by using fumaric acid, maleic acid and/or maleic anhydride as raw material during the preparation of the unsaturated polyester resin; itaconic building blocks are introduced in the unsaturated polyester resin by using itaconic acid and/or itaconic anhydride during the preparation of the unsaturated polyester resin. As used herein, all amounts in wt. % are given relative to the total weight of the unsaturated polyester resin based on fumaric, maleic and/or itaconic building blocks and vinyl ester and optional other reactive diluent, unless otherwise specified.

The unsaturated polyester resin as is comprised in the resin composition according to the invention may suitably be selected from the unsaturated polyester resins as are known to the skilled man. Unsaturated polyester resins are characterised by having carbon-carbon unsaturations which are in conjugation with a carbonyl bond. Examples of suitable unsaturated polyester resins to be used in the resin composition of the present invention are, subdivided in the categories as classified by M. Malik et al. in J. M. S. Rev. Macromol. Chem. Phys., C40(2&3), p. 139-165 (2000).
(1) Ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A. Commonly the ones derived from 1,2-propylene glycol are used in combination with a reactive diluent such as styrene.
(2) Iso-resins: these are prepared from isophthalic acid, maleic anhydride or fumaric acid, and glycols. These resins may contain higher proportions of reactive diluent than the ortho resins.
(3) Bisphenol-A-fumarates: these are based on ethoxylated bisphenol-A and fumaric acid.
(4) Chlorendics: are resins prepared from chlorinebromine containing anhydrides or phenols in the preparation of the UP resins.

Besides these classes of resins also so-called dicyclopentadiene (DCPD) resins can be distinguished as unsaturated polyester resins. The class of DCPD-resins is obtained either by modification of any of the above resin types by Diels-Alder reaction with cyclopentadiene, or they are obtained alternatively by first reacting a diacid for example maleic acid with dicyclopentadiene, followed by the usual steps for manufacturing a unsaturated polyester resin, further referred to as a DCPD-maleate resin. Furthermore, as mentioned above unsaturated polyester resins based on itaconic acid as unsaturated dicarboxylic acid can be used as well according to the invention.

Besides the unsaturated polyester resins also vinyl ester resins may be present. As used herein, a vinyl ester resin is a (meth)acrylate functional resin. The vinyl ester resin may suitably be selected from the vinyl ester resins as are known to the skilled man. Vinyl ester resins are mostly used because of their hydrolytic resistance and excellent mechanical properties. Vinyl ester resins having unsaturated sites only in the terminal position are for example prepared by reaction of epoxy oligomers or polymers (e.g. diglycidyl ether of bisphenol-A, epoxies of the phenol-novolac type, or epoxies based on tetrabromobisphenol-A) with for example (meth)acrylic acid. Instead of (meth)acrylic acid also (meth)acrylamide may be used. As used herein, a vinyl ester resin is an oligomer or polymer containing at least one (meth)acrylate functional end group, also known as (meth)acrylate functional resins. This also includes the class of vinyl ester urethane resins (also referred to as urethane (meth)acrylate resins). Preferred vinyl ester resins are methacrylate functional resins including urethane methacrylate resins and resins obtained by reaction of an epoxy oligomer or polymer with methacrylic acid or methacrylamide, preferably with methacrylic acid. Most preferred vinyl ester resins are resins obtained by reaction of an epoxy oligomer or polymer with methacrylic acid.

The unsaturated polyester resin as may be comprised in the resin composition according to the invention preferably has a molecular weight in the range from 500 to 10000 Dalton, more preferably in the range from 500 to 5000 even more preferably in the range from 750 to 4000. As used herein, the molecular weight of the resin is determined in tetrahydrofurane using gel permeation chromatography according to ISO 13885-1 employing polystyrene standards and appropriate columns designed for the determination of the molecular weights. The unsaturated polyester resin preferably has an acid value in the range from 5 to 80 mg KOHg resin, more preferably in the range from 10 to 70 mg KOHg resin. As used herein, the acid value of the resin is determined titrimetrically according to ISO 2114-2000.

The optional additional vinyl ester resin as may be comprised in the resin composition according to the invention preferably has a molecular weight in the range from 500 to 3000 Dalton, more preferably in the range from 500 to 1500. The vinyl ester resin preferably has an acid value in the range from 0 to 50 mg KOHg resin.

Besides the vinyl ester compound as reactive diluent, optionally also other reactive diluents may be present.

The total amount of reactive diluents in the resin composition according to the invention i.e. the vinyl ester compound with optionally other reactive diluents is in the range from 15 to 70 wt. %. The amount of vinyl ester compounds in the total amount of reactive diluent is between 40 and 100 wt. %, more preferably between 50 and 100 wt. %. These diluents and mixtures thereof will be applied, for instance, for lowering of the viscosity of the resin composition in order to make handling thereof more easy. For clarity purpose, a reactive diluent is a diluent that is able to copolymerize with the unsaturated polyester resin. Ethylenically unsaturated compounds can be advantageously used as additional reactive diluent such as styrene, substituted styrenes like α-methylstyrene, 4-methylstyrene; (meth)acrylates, N-vinylpyrrolidone and/or N-vinylcaprolactam. Preferably, (substituted)styrene, dialkyl itaconates like dimethyl itaconate and/or methacrylates are used as additional reactive diluents, more preferably dialkyl itaconates and methacrylates.

For obtaining improved mechanical properties the composition according to the invention preferably further comprises fibers. The type of fiber to be used depends on the type of application. According to another preferred embodiment the fibers are glass fibers. According to yet another preferred embodiment the fibers are carbon fibers.

For some applications, especially automotive applications, the compositions according to invention preferably further comprise low profile additives.

These type of additives enables to obtain an object with an improved surface quality. Examples of these additives are for instance polymers like saturated polyesters and polyvinyl acetate.

The resin composition according to the invention may further comprise fillers and/or pigments.

The resin composition may further comprise a radical inhibitor which retards the peroxide initiated radical copolymerization of the unsaturated polyester resin with the reactive diluent. These radical inhibitors are preferably chosen from the group of phenolic compounds, hydroquinones, catechols, benzoquinones, stable radicals and/or phenothiazines. The amount of radical inhibitor that can be added may vary within rather wide ranges, and may be chosen as a first indication of the gel time as is desired to be achieved.

Suitable examples of radical inhibitors that can be used in the resin compositions according to the invention are, for instance, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (a compound also referred to as TEMPOL), 1-oxyl-2,2,6,6-tetramethylpiperidine-4-one (a compound also referred to as TEMPON), 1-oxyl-2,2,6,6-tetramethyl-4-carboxyl-piperidine (a compound also referred to as 4-carboxy-TEMPO), 1-oxyl-2,2,5,5-tetramethylpyrrolidine, 1-oxyl-2,2,5,5-tetramethyl-3-carboxylpyrrolidine (also called 3-carboxy-PROXYL), galvinoxyl, aluminium-N-nitrosophenyl hydroxylamine, diethylhydroxylamine, phenothiazine and/or derivatives or combinations of any of these compounds.

Advantageously, the amount of radical inhibitor in the resin composition according to the invention is in the range of from 0,0001 to 10% by weight. More preferably, the amount of inhibitor in the resin composition is in the range of from 0,001 to 1% by weight. The skilled man quite easily can assess, in dependence of the type of inhibitor selected, which amount thereof leads to good results according to the invention.

The invention further relates to a two-component system wherein the first component is a resin composition as described above and wherein the second component comprises a peroxide. The two-component systems according to the invention are suitable for being applied in structural applications. As used herein, suitable for structural applications means that the resin composition upon curing by means of peroxide initiated radical copolymerization results in structural parts. As meant herein, structural parts are considered to have a thickness of at least 0.5 mm and appropriate mechanical properties. The term “structural parts” as meant herein also includes cured resin compositions as are used in the field of chemical anchoring, construction, roofing, flooring, windmill blades, containers, tanks, pipes, automotive parts, boats, etc. The present invention therefore also relates to the use of such a two-component composition in any one of the areas of chemical anchoring, construction, roofing, flooring, windmill blades, containers, tanks, pipes, automotive parts or boats. The present invention also relates to cured objects or structural parts obtained by mixing the two components of such a two-component system.

As used herein, the term “two-component system” refers to systems where two separate components (A and B) are being spatially separated from each other, for instance in separate cartridges or the like, and is intended to include any system wherein each of such two separate components (A and B) may contain further separate compounds. The components are combined at the time the system is used.

According to the present invention, compositions with good curing properties can be obtained, i.e. the compositions, obtained by mixing the two components of the two-component system according to the invention, have short gel time, short peak time and/or high peak temperature. In the curing of unsaturated polyester resins, gel time is a very important characteristic of the curing properties. In addition also the time from reaching the gel time to reaching peak temperature, and the level of the peak temperature (higher peak temperature generally results in better curing) are important.

The peroxide is preferably selected from the group of hydroperoxides, peresters, percarbonates and perketones. The peroxide being most preferred in terms of handling properties and economics is methyl ethyl ketone peroxide (MEK peroxide). The amount of peroxide can be varied within wide ranges, in general less than 20 wt. %, and preferably less than 10 wt. %.

The present invention further also relates to a process for peroxide initiated radical copolymerisation of a resin composition as described above whereby the radical copolymerisation is performed by mixing the two component of the two-component system as described above. Preferably, the radical copolymerisation is effected essentially free of cobalt. Essentially free of cobalt means that the cobalt concentration is lower than 0.02 mmol Co per kg unsaturated polyester resin and vinyl ester, preferably lower than 0.01 mmol Co per kg unsaturated polyester resin and vinyl ester. Most preferably the two-component composition is free of cobalt

Preferably, the radical copolymerisation is effected at a temperature in the range of from −20 to +200° C., preferably in the range of from −20 to +150° C., more preferably in the range of from −10 to +80° C. and even more preferably at room temperature (from 20 up to and including 25° C.).

The invention is now demonstrated by means of a series of examples and comparative examples. All examples are supportive of the scope of claims. The invention, however, is not restricted to the specific embodiments as shown in the examples.

### Experimental Part

Dimethyl 2,4-di-(2-pyridyl)-3-methyl-7-(pyridine-2-ylmethyl)-3,7-diaza-bicyclo[3.3.1]nonan-9-one-1,5-dicarboxylate (N2Py3o) and the iron (II) complex thereof [Fe(N2Py3o)Cl]Cl was prepared as followed (following the procedure described in WO0248301, page 28-34).

Preparation of dimethyl 2,6-di-(2-pyridyl)-1-methyl-piperid-4-one-3,5-dicarboxylate (NPy2)

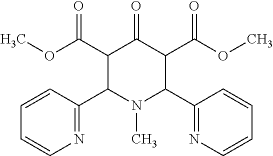 [SMILES: COC(=O)C1C(=O)C(C(=O)OC)C(c2ccccn2)N(C)C1c1ccccn1]

2-Pyridinecarboxaldehyde (166.3 mmol; 17.81 g) was added drop wise to an ice-bath cooled solution of dimethyl-1,3-acetonedicarboxylate (83.1 mmol; 14.48 g) in methanol (60 ml). Next an aqueous solution (40%) of methylamine (83.1 mmol; 6.5 g) was added. The solution was stirred for 15 minutes at 0° C. and then left at 19° C. for seven days. At this time crystals were formed that were removed by filtration and washed with cold ethanol. The yield of the title compound was 23.90 g, and it was used for further synthesis without further purification.

### Preparation of dimethyl 2,4-di-(2-pyridyl)-3-methyl-7-(pyridine-4-ylmethyl) 3,7-diaza-bicyclo[3.3.1]nonan-9-one-1,5-dicarboxylate (N2Py2Py′o) (Ra=methylene-4-pyridyl)

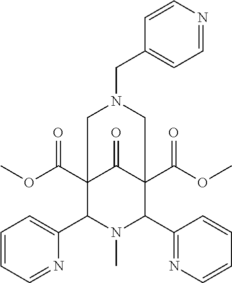 [SMILES: COC(=O)C12CN(Cc3ccncc3)CC(C(=O)OC)(C1=O)C(c1ccccn1)N(C)C2c1ccccn1]

To a suspension of NPy2 (32.3 mmol; 12.38 g) in 175 ml of ethanol was added an aqueous (37%) formaldehyde solution (81 mmol; 6.63 g) followed by 4-picolylamine (37.2 mmol; 4.02 g). The yellow suspension was stirred under reflux for 30 minutes, after which the suspension was turned in a clear brown solution. The solvent was removed under reduced pressure and the remaining solid was crystallized from methanol to yield 4 g (25%) of the title compound as a white solid.

### Preparation of dimethyl 2,4-di-(2-pyridyl)-3-methyl-7-(pyridine-2-ylmethyl) 3,7-diaza-bicyclo[3.3.1]nonan-9-one-1,5-dicarboxylate (N2Py3o) (Ra=methylene-2-pyridyl)

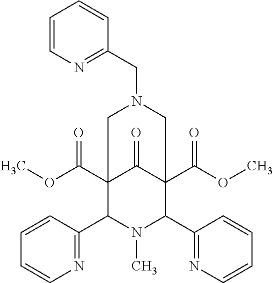 [SMILES: COC(=O)C12CN(Cc3ccccn3)CC(C(=O)OC)(C1=O)C(c1ccccn1)N(C)C2c1ccccn1]

To a suspension of NPy2 (32.3 mmol; 12.38 g) in 175 ml of ethanol was added an aqueous (37%) formaldehyde solution (81 mmol; 6.63 g) followed by 2-picolylamine (37.2 mmol; 4.02 g). The yellow suspension was stirred under reflux for 30 minutes, after which the suspension was turned in a clear brown solution. The solvent was removed under reduced pressure and the remaining solid was crystallized from ethanol to yield 3.9 g (23%) of the title compound as a white solid.

### Preparation of chloro(dimethyl-2,4-di-(2-pyridyl)-3-methyl-7(pyridine-2-ylmethyl)-3,7-diaza-bicyclo[3.3.1]nonan-9-one-1,5-dicarboxylate)iron(II)-chloride hydrate ([Fe(N2Py3o)Cl]Cl)

Solution of 0.254 g (2.0 mmol) of FeCl2 in 1.0 ml of methanol was added to a solution of 1.030 g (2.0 mmol) of N2Py3o in 2 ml of methanol. After one day orange-yellow crystals precipitated from the dark brown solution.

The crystals were filtered and dried.

The crystals were either dissolved in (a) 1,2-propylene glycol to obtain a 1% solution in 1,2-propylene glycol (further referred to as solution (a)) or in (b) methanol to obtain a 10% solution in methanol (further referred to as solution (b)).

### Resin A Synthesis

An unsaturated polyester resin was prepared by polycondensation of 105 parts of maleic anhydride, 314 parts of phthalic anhydride, 244 parts of 1,2-propylene glycol. The starting compounds were charged into a reactor equipped with condenser, stirrer, a temperature control system and an inlet for nitrogen. Under a gentle flow of nitrogen, the reaction mixture was heated up and maintained at a temperature of 210° C. The acid value dropped slowly and at the end of the process vacuum was applied to help stripping the water from the reaction mixture to reach the targeted acid value and viscosity. An acid value of 52 and a viscosity of 364 mPa·s was reached. The so obtained resin is further referred to as resin A.

### Resin B Synthesis

An unsaturated polyester resin was prepared by polycondensation of 102 parts of maleic anhydride, 77 parts of phthalic anhydride, 121 parts of 1,2-propylene glycol. The starting compounds were charged into a reactor equipped with condenser, stirrer, a temperature control system and an inlet for nitrogen. Under a 20 gentle flow of nitrogen, the reaction mixture was heated up and maintained at a temperature of 210° C. The acid value dropped slowly and at the end of the process vacuum was applied to help stripping the water from the reaction mixture to reach the targeted acid value and viscosity. An acid value of 51 and a viscosity of 310 mPa·s was reached. The so obtained resin is further referred to as resin B.

The peroxides used for curing are commercially available products from Akzo Nobel Inc.

### Monitoring of Curing

In the Examples presented hereinafter it is mentioned, that curing was monitored by means of standard gel time equipment. This is intended to mean that both the gel time (T_{gel} or T_{25→35° C.}) and peak time (Tₚₑₐₖ or T_{25→peak}) were determined by exotherm measurements according to the method of DIN 16945 when curing the resin with the peroxides as indicated in the Examples and Comparative Examples. The equipment used therefore was a Soform gel timer, with a Peakpro software package and National Instruments hardware; the waterbath and thermostat used were respectively Haake W26, and Haake DL30.

### EXAMPLE 1-3 AND COMPARATIVE EXPERIMENT A1-A2

187 g of resin A were dissolved in 82.1 g vinyl benzoate and 42.7 g divinyl adipate. In example 1-3, to 25 g samples of this diluted resin, various amounts of the iron complex solution (b) in methanol were added (see Table 1). In comparative example A1, 16.7 mg of NL-49P Co solution (Akzo) was added. A stock solution of vanadium(III)2,4-pentanedionate (Gelest Inc.) in acetylacetone (8%) was prepared. In comparative example A2, 68.5 mg of the vanadium solution was added to 25 g of the diluted resin.

Curing was performed using 2% Butanox M50 and the cure was monitored with the gel timer.

TABLE 1

| | | mmol metal/ | | | Peak |
|---|---|---|---|---|---|
| | | kg | Gel time | Peak time | temperature |
| 1 | Fe | 0.1 | 11.6 | 23.2 | 59 |
| 2 | Fe | 0.5 | 4.9 | 12.7 | 148 |
| 3 | Fe | 1 | 53.1 | 64.8 | 140 |
| Comp A1 | Co | 0.1 | No cure | | |
| Comp A2 | V | 0.1 | No cure | | |

These examples clearly show that various amounts of iron complex can be used. Comparing example 1 with comparative experiments A1, A2 in which the cure systems as used in J. App. Polym. Sci. vol 27, p 3584 (1982) of Froehling et al. were used with the same amount of metal clearly demonstrates that the iron complexes according to the invention outperform the known systems as in these low amounts no sufficient curing is observed with the comparative samples. Furthermore all samples according to the invention resulted in slightly yellow cured objects whereas the uncured liquid of Comp A was light pink and the uncured liquid of Comp B was green.

### EXAMPLE 4-6 AND COMPARATIVE EXAMPLES B1-B17

To 24 g of resin A dissolved in 10.53 g vinyl benzoate and 5.48 g divinyl adipate were added 0.02 mmol of various transition metals (as 1% solutions) and 4.1 mg of various ligands (0.04 mmol). After storing the obtained resin mixtures for 1 month, the resin mixtures were cured using 80 mg Butanox M50 and curing was monitored in the gel timer (see Table 2).

TABLE 2

| | | | | | Peak |
|---|---|---|---|---|---|
| | | | Tgel | Tpeak | temp |
| Example | Metal salt | Ligand | (min) | (min) | (° C.) |
| 4 | Fe(III) ethyl- | (N2Py3o) | 6.5 | 13.9 | 131 |
| | hexanoate | | | | |
| 5 | Fe (II) naph- | (N2Py3o) | 8.2 | 21.4 | 122 |
| | thenate | | | | |
| 6 | FeCl₂ | (N2Py3o) | 5.9 | 13.2 | 140 |
| Comp. B1 | Mn(II) ethyl- | (N2Py3o) | >1200 | | |
| | hexanoate | | | | |
| Comp. B2 | Mn(II) naph- | (N2Py3o) | >1200 | | |
| | thenate | | | | |
| Comp. B3 | Co octanoate | (N2Py3o) | >1200 | | |
| Comp. B4 | Fe(III) ethyl- | (N2Py2Py′o) | >1200 | | |
| | hexanoate | | | | |
| Comp. B5 | Fe(II) naph- | (N2Py2Py′o) | >1200 | | |
| | thenate | | | | |
| Comp. B6 | FeCl₂ | (N2Py2Py′o) | >1200 | | |
| Comp. B7 | Mn(II) naph- | (N2Py2Py′o) | >1200 | | |
| | thenate | | | | |
| Comp. B8 | Co octanoate | (N2Py2Py′o) | >1200 | | |
| Comp. B9 | Fe(III) ethyl- | (NPy2) | >1200 | | |
| | hexanoate | | | | |
| Comp. B10 | Fe (II) naph- | (NPy2) | >1200 | | |
| | thenate | | | | |
| Comp. B11 | FeCl₂ | (NPy2) | >1200 | | |
| Comp. B12 | Mn(II) ethyl- | (NPy2) | >1200 | | |
| | hexanoate | | | | |
| Comp. B13 | Mn(II) naph- | (NPy2) | >1200 | | |
| | thenate | | | | |
| Comp. B14 | Co octanoate | (NPy2) | >1200 | | |
| Comp. B15 | | (N2Py2Py′o) | >1200 | | |
| Comp. B16 | | (NPy2) | >1200 | | |
| Comp B17 | | N2Py3o) | >1200 | | |

As further comparisons, 1 wt. % tetrahydrofuran, 1 wt. % dimethylformamide or 1 wt. % ethylacetate were added to the resin formulations containing either Fe(III) ethyl hexanoate or Fe(II) naphthenate. In none of these comparative experiments any curing was observed.

Examples 4-6 clearly show that the iron-ligand complex can be formed in situ from an iron solution and the ligand. Thus adding an iron salt and the ligand according to formula (1) separately to the resin composition also gives good curing. As comparison, an active complex cannot be formed in situ with other transitions metals (comp. examples B1-B3). With the ligands (N2Py2Py′o) and (NPy2) no cure was observed indicating that Ra must be a 2-pyridyl group or an alkylidene-2-pyridyl group (comp. examples B4-8, B9-B13).

### EXAMPLE 7-13

24 g of resin A were dissolved in various amounts of vinyl benzoate, divinyl adipate, vinyl versatate (Veova 9, Momentive Specialty Chemicals Inc.) (see Table 3). In Example 7-9 264 mg of the iron complex solution (b) in methanol (10%) was used resulting in a metal content of 0.5 mmolkg and in examples 10-13, the metal content was doubled (1 mmolkg). Curing was performed using 2% Butanox M50 and the cure was monitored with the gel timer.

TABLE 3

| | Amount | | Amount | | | |
|---|---|---|---|---|---|---|
| | reactive | | reactive | | | Peak |
| | diluent 1 | | diluent 2 | Gel time | Peak time | temperature |
| 7 | 9.34 | g VP | | 5.1 | 13.2 | 126 |
| 8 | 8.84 | g VB | 3.68 g VV9 | 7.7 | 21.9 | 99 |
| 9 | 16 | g DVA | | 3.4 | 7.8 | 176 |
| 10 | 16 | g VB | | 61.3 | 83.5 | 109 |
| 11 | 13.93 | g VB | 2.07 g DVA | 48.1 | 62.2 | 136 |
| 12 | 0.211 | g VB | 5.83 g DVA | 27.5 | 35.2 | 155 |
| 13 | 6.86 | g VB | 9.15 g DVA | 2.6 | 7.8 | 170 |

VB = vinyl benzoate
DVA = divinyl adipate
VP = vinyl propionate
VV9 = vinyl versatate (Veova 9)

This example clearly shows that various vinyl esters in various amounts can be used.

### EXAMPLE 14-17

70 g of resin B were dissolved in various amounts of vinyl ester reactive diluent (see Table 4). 1.375 mg of the iron complex solution (a) in propylene glycol (1%) was used for curing. This corresponds to an iron content of 0.3 mmolkg resin. After addition of 2% Butanox M50, small round castings of 4 mm thickness were prepared. After cure, the castings were postcured first for 2 hours at 80° C., then for 2 hours at 120° C. and finally for 4 hours at 150° C. Samples from these castings were analyzed by dynamic mechanical analysis (DMA).

TABLE 4

| | | | | | Glass | Modulus |
|---|---|---|---|---|---|---|
| | | | | | transition | G′ at |
| | | | | Modulus | temperature | 200° C. |
| | Amount | | Amount | G′ at | by max. | (rubber |
| | reactive | | reactive | 25° C. | tan delta | modulus) |
| | diluent 1 | | diluent 2 | (MPa) | (° C.) | (MPa) |
| 14 | 28 | g VB | — | 3650 | 113 | 44 |
| 15 | 22.65 | g VB | 5.35 g DVA | 3320 | 118 | 83 |
| 16 | 28 | g VAc | — | 3750 | 114 | 67 |
| 17 | 19.9 | g VAc | 8.1 g DVA | 3410 | 120 | 150 |

VB = vinyl benzoate
DVA = divinyl adipate
VAc = vinyl acetate

These examples show that the unsaturated polyester resin diluted as in Example 14-17 can be cured according to the invention and that the cured materials show good mechanical properties as required for cured objects and structural parts.

1. Unsaturated polyester resin composition characterized in that the resin composition comprises
a. An unsaturated polyester resin comprising fumaric, maleic and/or itaconic building blocks,
b. At least one vinyl ester as reactive diluent,
c. An iron complex and/or salt, and
d. A ligand according to the following formula (1) 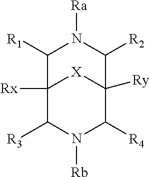
wherein each R₁, R₂, R₃ and R₄ are independently selected from hydrogen, C1-C12 alkyl, C3-C8 cycloalkyl, C6-C12 aryl and C5-C12 heteroaryl;
X is selected from C═O and —[C(R)₂]_{z}— wherein z is from 1 to 3 and each R is independently selected from hydrogen, hydroxyl, C1-C4 alkoxy and C1-C4 alkyl;
each Rx and Ry are independently selected from hydrogen, C1-C8 alkyl, (C1-C8)alkyl-O-(C1-C8)alkyl, (C1-C8)alkyl-O-(C6-C10)aryl, C6-C10-aryl, C1-C8 hydroxyalkyl, and (CH₂)ₙC(O)OR₅ wherein n is from 0 to 4 and R₅ is hydrogen, C1-C12 alkyl or an amide;
Ra is a 2-pyridyl group or an alkylidene-2-pyridyl group;
Rb is selected from C1-C24 alkyl, C6-C10 aryl and a group containing a heteroatom.

2. Resin composition according to claim 1, wherein the resin composition comprises an iron complex with the ligand according to formula (1).

3. Resin composition according to claim 1, wherein Ra is methylene-2-pyridyl, R₃ and R₄ is a 2-pyridyl group, R₁ and R₂ is hydrogen, X is C═O, Rx and Ry are C(O)OR₅ and Rb is methyl.

4. Resin composition according to claim 1, wherein the resin composition comprises a vinyl ester according to formula (2) 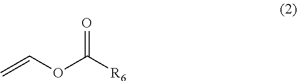
in which R6 is a C1-C24 alkyl, C6-C12 aryl, C7-C18 aryl alkyl or a C7-C18 alkyl aryl (which may be substituted with a hetero-atom).

5. Resin composition according to claim 1, wherein the resin composition comprises a vinyl ester according to formula (3) 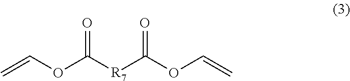
in which R7 is a C1-C24 alkyl, C6-C12 aryl, C7-C18 aryl alkyl or a C7-C18 alkyl aryl (which may be substituted with a hetero-atom).

6. Resin composition according to claim 1, wherein the ligand is present in an amount of from 1 to 2000 μmol per kilogram of primary resin system.

7. Resin composition according to claim 1, wherein the molar ratio of iron to ligand is from 0.02 to 20.

8. Resin composition according to claim 1, wherein the resin composition further comprises (substituted) styrene, dialkyl itaconates and/or a methacrylate as reactive diluent

9. Two-component system, wherein the first component is a resin composition according to claim 1 and wherein the second component comprises a peroxide.

10. Two-component system according to claim 9, wherein the peroxide is selected from the group of hydroperoxides, peresters, percarbonates and perketones.

11. Process for peroxide initiated radical copolymerisation of a resin composition comprising an unsaturated polyester resin and a vinyl ester reactive diluent, wherein the radical copolymerisation is performed by mixing the two components from the two-component system according to claim 9.

12. Process according to claim 11, wherein the curing is effected at room temperature.

13. Use of the two-component composition according to claim 9, in any one of the areas of chemical anchoring, construction, roofing, flooring, windmill blades, containers, tanks, pipes, automotive parts or boats.

14. Cured objects or structural parts obtained by mixing the two components of the two-component system according to claim 9.
